(19) United States
(12) Patent Application Publication
(10) Pub. No.: US 2024/0101913 A1
(43) Pub. Date: Mar. 28, 2024

(54) HYDROCRACKING OPERATION WITH REDUCED ACCUMULATION OF HEAVY POLYNUCLEAR AROMATICS

(71) Applicant: CHEVRON U.S.A. INC., San Ramon, CA (US)

(72) Inventors: Ling JIAO, Richmond, CA (US); Bi-Zheng ZHAN, Albany, CA (US); Don BUSHEE, San Ramon, CA (US); Theodorus Ludovicus Michael MAESEN, Moraga, CA (US); Hye-Kyung TIMKEN, Albany, CA (US); Richard DUTTA, San Ramon, CA (US); Jay PAREKH, San Ramon, CA (US)

(73) Assignee: CHEVRON U.S.A. INC., San Ramon, CA (US)

(21) Appl. No.: 18/270,202

(22) PCT Filed: Dec. 29, 2021
(86) PCT No.: PCT/IB2021/062438

§ 371 Date: Jun. 28, 2023

Related U.S. Application Data
(63) Continuation of application No. 17/137,928, filed on Dec. 30, 2020.

(51) Int. Cl. C10G 65/12; C10G 7/00; C10G 47/14

(52) U.S. Cl. CPC C10G 65/12; C10G 7/00; C10G 47/14; C10G 2300/107; C10G 2300/1074; C10G 2300/4006; C10G 2300/4081

(57) ABSTRACT

Provided is a hydrocracking process with a recycle loop for converting a petroleum feed to lower boiling products, which process comprises reacting a stream over a non-zeolite noble metal catalyst at a temperature of about 650° F. (343° C.) or less in a reactor positioned in the recycle loop of the hydrocracking reactor.

### CROSS REFERENCE TO RELATED APPLICATIONS

This application claims the benefit of priority to U.S. patent application Ser. No. 17/137,928, filed on Dec. 30, 2020, the disclosure of which is herein incorporated in its entirety.

### TECHNICAL FIELD

Controlling the accumulation of heavy polynuclear aromatics in a two-stage hydrocracking operation.

### BACKGROUND

A refinery's flexibility and responsiveness to market dynamics and regulatory environments has a major impact on its competitive position. Several factors drive this need for responsiveness including the availability of inexpensive opportunity crudes and compatible cutter stocks, tightening regulations on residual fuel oil, and price differentials between petrochemical feedstocks, base oil and transportation fuels. Tighter specifications on refinery process schemes combined with more robust catalyst systems affords more sustainability turning a larger portfolio of opportunity feedstocks into a product slate that is more in sync with the market dynamics.

Refineries impose constraints on operations to maximize operational reliability. Recent process and catalyst options have been developed that significantly reduce and refine these constraints postures. With the production of light crudes and heavy crudes increasing and with medium crudes in decline, more and more refineries are feeding opportunity blends of light and heavy crudes. These crude blends raise compatibility concerns, and they can challenge the distillation train, which frequently exacerbates entrainment of residual oil in the hydrocracker feed. Entrained residual oil has a deleterious impact on hydrocracker performance, even if the entrainment is so small that it is close to the detection limit of standard analytical techniques. If capital is available, one can invest in improved process options to improve the hydrocracker feedstock, and thereby mitigate the exposure to the negative impact of opportunity crudes. Illustrating the current urgency of the need to address compatibility issues, solutions such as distillation and absorption of the offending components are currently being put into practice, long after they were initially proposed. A capital-neutral solution is a catalyst system that can mitigate the risk associated with only a minor increase in end boiling point of the feedstock to the hydrocracker.

Residual oil entrained in the feed to a hydrocracker designed to hydroprocess vacuum gas oil is a problem, because parts of the residual oil frequently do not maintain their compatibility once the feed starts to be hydroprocessed. Compatibility is lost because hydroprocessing strips the complex residual oil molecules initially dissolved in the feed down to polycyclic aromatic cores, while simultaneously saturating the feed into a less aromatic stream that is less hospitable to large aromatics. Compatibility is further reduced by the condensation of smaller aromatics into thermodynamically more favored larger configurations. This simultaneous formation of a more aromatic solute and a less aromatic solvent can create nano-emulsions, which can form mesophases (liquid crystals) that can ultimately sediment out either inside the reactor or inside equipment downstream from the reactor.

The most problematic issue relates to heavy polynuclear aromatics. Heavy polynuclear aromatics (HPNA) are polycyclic aromatic compounds which have multiple aromatic rings in the molecular structure. The presence of HPNA in commercial hydrocrackers can foul process equipment due to the precipitation of HPNA in heat exchangers and lines. It can also result in fast catalyst deactivation, because HPNA precipitates out and deposits on catalyst surface, blocking active sites. HPNA is not only present in the hydrocracking feedstock, it also forms during hydroprocessing processes, especially in the second stage hydrocracker recycle loop where HPNA forms at normal operating conditions and becomes more and more concentrated overtime on stream.

This issue has been a difficult problem for hydrocrackers in the refineries all over the world for decades. Most refineries are forced to continuously bleed some of the recycle stream to prevent fast HPNA accumulation. The amount bled can range from 5 up to 20 wt. % of the recycle stream. This results in significant material loss. Although some companies have developed certain technology trying to mitigate this issue, such as an active carbon adsorbent in the recycle loop in an attempt to selectively remove HPNA, it does not target the root cause and prevent the formation of HPNA. In addition, the separation and removal of HPNA via a physical route is not always very effective, and it might also cause material loss due to imperfect separation.

An approach for eliminating or at least substantially reducing the formation and accumulation of HPNA in a two-stage hydrocracker, especially a two-stage hydrocracker employing a base metal catalyst in the second reactor, would be of great value in the industry.

### SUMMARY

Provided is a hydrocracking process with a recycle loop for converting a petroleum feed to lower boiling products. The process comprises reacting a hydrocarbon stream in a reactor comprising a non-zeolite noble metal catalyst at a temperature of about 650° F. (343° C.) or less, with the reactor positioned in the recycle loop of the hydrocracking process.

Provided in one embodiment is a two-stage hydrocracking process for converting a petroleum feed to lower boiling products, which process comprises reacting a stream over a non-zeolite noble metal catalyst at a temperature of about 650° F. (343° C.) or less in a reactor positioned in the recycle loop of the second stage hydrocracking reactor.

In an embodiment, provided is a hydrocracking process with recycle for converting a petroleum feed to lower boiling products, which process comprises hydrotreating a petroleum feed in the presence of hydrogen to produce a hydrotreated effluent stream comprising a liquid product in a first reactor. At least a portion of the hydrotreated effluent stream is passed to a separation section. At least a portion of a bottoms fraction of the separation section is passed to a reactor comprising a non-zeolite noble metal catalyst, which reactor is positioned between the separation section and a hydrocracking reactor, and is run at a temperature of about 650° F. (343° C.) or less. The product from the reactor comprising the non-zeolite noble metal catalyst is passed to a hydrocracking reactor to produce a hydrocracked effluent stream. A bottoms fraction from the hydrocracking reactor is recovered and at least a portion of the bottoms fraction recovered is passed through the separation section.

In another embodiment, provided is a two-stage hydrocracking process with recycle for converting a petroleum feed to lower boiling points. The process comprises hydrotreating a petroleum feed in a first stage reactor in the presence of hydrogen to produce a hydrotreated effluent stream comprising a liquid product. At least a portion of the hydrotreated effluent stream is passed to a separation section such as a distillation column. A bottoms fraction of the distillation column, at least a portion, is passed to a hydrocracking stage in a second reactor to produce a hydrocracked effluent stream. A bottoms fraction from the second reactor is recovered and recycled to the distillation column or the hydrotreated effluent stream passed to the distillation column. The recycle stream is passed to a reactor comprising a non-zeolite noble metal catalyst, which reactor is positioned between the hydrocracking reactor and the distillation column, and is run at a temperature of 650° F. (343° C.) or less. The recycle stream is passed through this non-zeolite noble metal catalyst reactor before reaching the distillation column or the hydrocracked effluent stream passed to the distillation column.

In an embodiment this is provided a hydrocracking process with a recycle loop for converting a petroleum feed to lower boiling products. The process comprises reacting a hydrocarbon stream in a reactor comprising a noble metal catalyst with a support having mesopores and macropores, with the reactor run at a temperature of about 650° F. (343° C.) or less, and with the reactor positioned in the recycle loop of the hydrocracking process.

Among other factors, it has been found that by using a non-zeolite noble metal catalyst in the recycle loop of a hydrocracking process, e.g., in the recycle loop of a second stage reactor, when operated at low temperature, one can saturate and convert HPNA. This prevents concentration of HPNA in the recycle loop, which if not addressed can eventually lead to equipment fouling and catalyst deactivation. This approach helps mitigate material loss due to necessary bleeding of the recycle stream. The approach minimizes the bleed, for example, to a FCC unit. It also enhances the second stage catalyst life and run length, and provides an opportunity to process heavier feedstock in two-stage hydrocrackers.

### BRIEF DESCRIPTION OF THE DRAWINGS

FIG. 1 depicts a traditional two-stage hydrocracker system with the second stage recycle loop indicated.

FIG. 2 schematically depicts an embodiment employing the non-zeolite catalyst in the recycle loop upstream of the second stage of a two-stage hydrocracking system.

FIG. 3 schematically depicts an embodiment employing the non-zeolite catalyst in the recycle loop downstream from the second stage of a two-stage hydrocracking system.

FIG. 4 schematically depicts a two-stage hydrocracker system with the separation section after the second stage, with the recycle to the feed of the first stage reactor, and with the non-zeolite catalyst in the recycle loop between the separation section and the feed to the first stage reactor.

FIG. 5 schematically depicts another hydrocarbon process with a recycle loop where the non-zeolite catalyst is in the recycle loop between the separation section and the second stage reactor.

FIG. 6 graphically demonstrates the pore size distribution of, in one embodiment, a useful non-zeolite noble metal catalyst.

FIG. 7 shows the structure of three particular heavy polynuclear aromatic species (benzoperylene; coronene, and ovalene).

FIG. 8 graphically depicts the testing results of Example 1 in which HPNAs are saturated and converted.

FIG. 9 graphically depicts the testing results of Example 1 in which the feed tested was a coronene spiked feed.

FIG. 10 graphically depicts the impact of LHSV and temperature on conversion of HPNAs.

FIG. 11 graphically depicts the impact of operating pressure and temperature on conversion of HPNAs.

### DETAILED DESCRIPTION

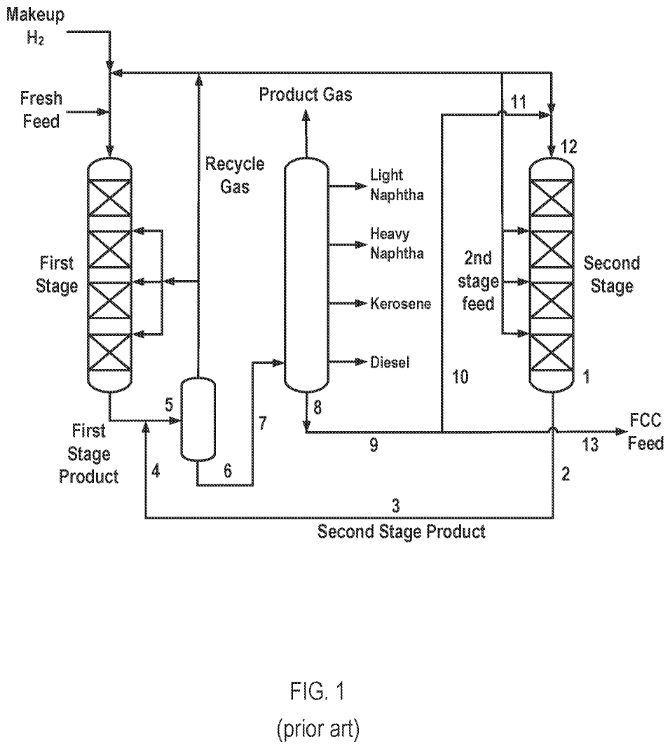

The present processes relate to a method of controlling heavy polynuclear aromatics (HPNA) formation and accumulation in two-stage hydrocrackers, particularly when a base metal catalyst is used in the second stage. FIG. 1 depicts a traditional two-stage hydrocracker system. Heavy polynuclear aromatics (HPNA) form in the second stage reactor 1 using a base metal catalyst which is typically operated above 650° F. (343° C.). The HPNA becomes more and more concentrated in the second stage recycle loop (indicated by conduits 2-12 in FIG. 1) over time on stream. Eventually those concentrated HPNA will precipitate out and deposit on the surface of the catalysts, and inside heat exchangers and lines. That will result in rapid catalyst deactivation and equipment fouling. In order to control the accumulation of HPNA in the second stage recycle loop to a manageable level, refineries usually have to continuously bleed some of recycle stream (sent to FCC via conduit 13), which causes significant material loss. This is especially true toward the end of the run due to the very large bleed rate needed to sustain unit operation because of highly concentrated HPNA in the second stage recycle loop.

The present process uses a non-zeolite noble metal catalyst reactor operated at low temperature (about 650° F. or less) in the liquid recycle loop of the second stage hydrocracker. In one embodiment, the temperature at which the reactor comprising the non-zeolite noble metal catalyst is run is about 550° F. (288° C.) or less, and in an embodiment, at about 500° F. (260° C.) or less. In another embodiment, the run temperature is in the range of from about 400° F. to about 500° F. (204° C. to 260° C.).

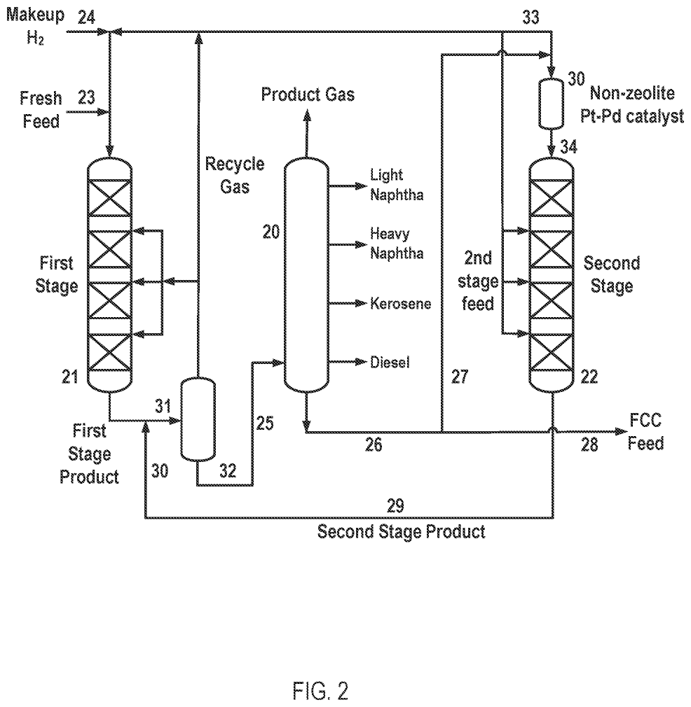

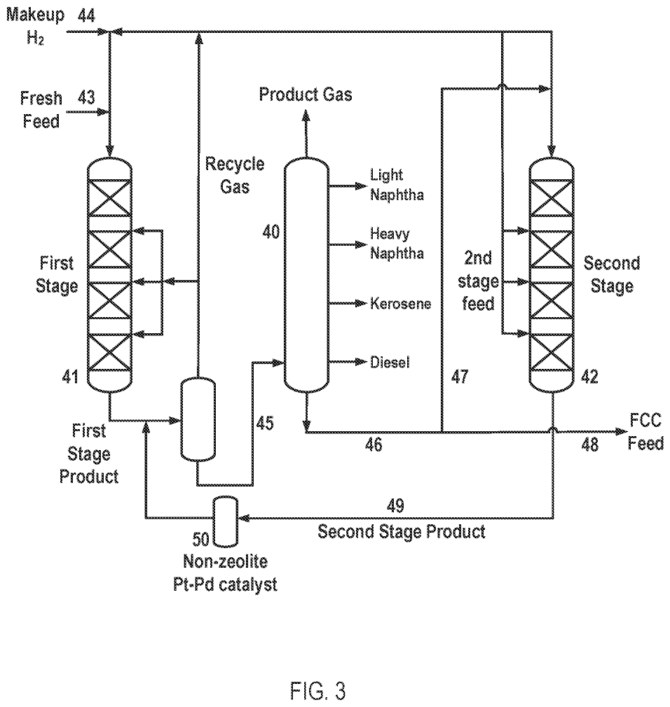

FIG. 2 shows a flow diagram of a two-stage hydrocracker with the additional reactor loaded with non-zeolite Pt—Pd catalyst installed in the liquid recycle loop upstream of the second stage reactor, generally loaded with base metal catalysts. The second stage feed in the recycle loop will be processed by the non-zeolite Pt—Pd catalyst which is operated at low temperature. The heavy polynuclear aromatics (HPNA) forming in the second reactor with base metal catalyst is effectively saturated and converted, before recycling to the second stage reactor. FIG. 3 shows a two-stage hydrocracker with the additional reactor loaded in the recycle loop downstream of the second stage reactor column. Again, with the non-zeolite noble metal catalyst reactor positioned in the recycle loop, the HPNA forming in the second stage reactor are effectively saturated and converted.

This method can have the additional reactor essentially positioned anywhere in the second stage recycle loop. The second stage recycle loop includes the conduits and equipment through which bottoms from the second stage reactor column is recycled and eventually loops back or returns to the second stage reactor. The loop is indicated by conduits 2-12 in FIG. 1, also including the distillation column and of course the second stage reactor column. Employing this reactor in the second stage reactor recycle loop has been found to inhibit the concentration of HPNA in the second stage, and thus enhance catalyst life and prevent equipment fouling. Meanwhile, bleeding recycle stream will be reduced or eliminated. Instead of from 5-20 wt. % bleed to FCC, the present processes can reduce the bleed to 0-4 wt. % and generally less than 1 wt. %. Totally eliminating the need for the bleed is also possible.

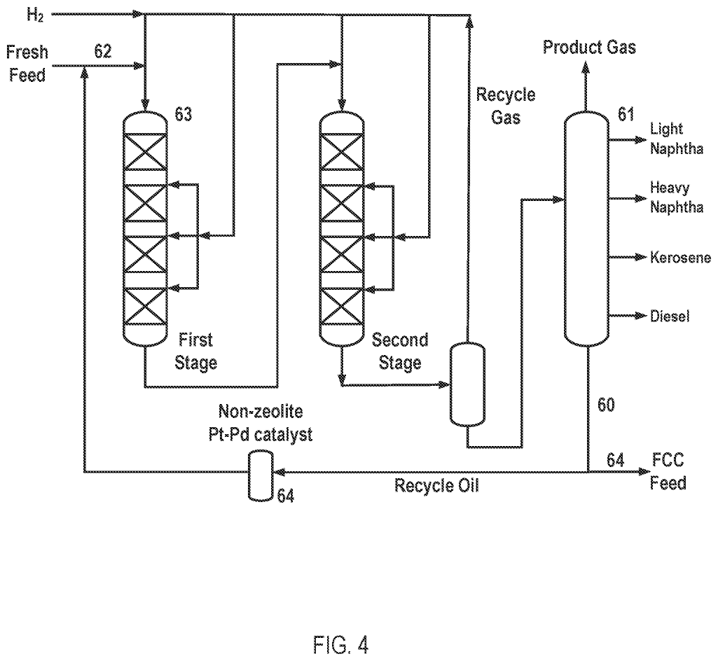

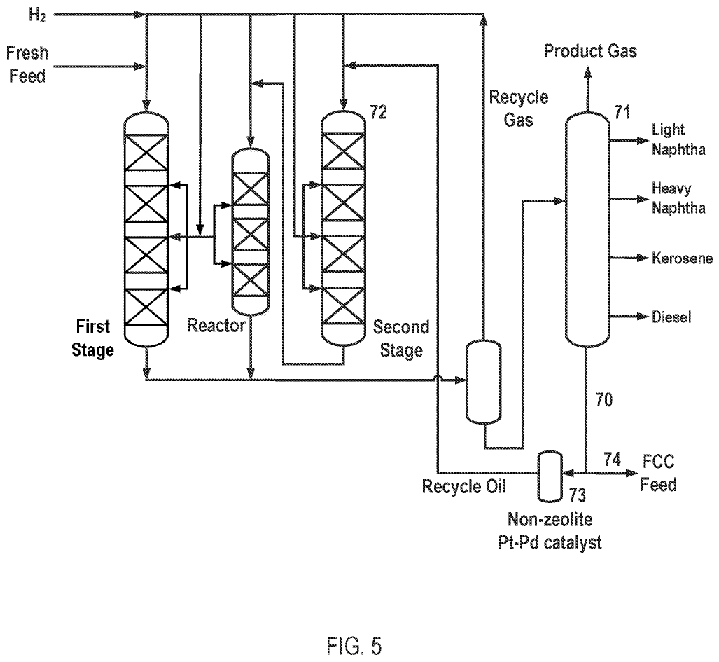

FIGS. 4 and 5 depict other hydrocarbon processes in which the reactor comprising the non-zeolite noble metal catalyst is employed in the recycle loop. In FIG. 4, the recycle loop includes the bottoms 60 of the separation section 61, and passes the feed 62 to the first reactor 63. The reactor comprising the non-zeolite noble metal catalyst is at 64, between the separation section 61 and the feed 62. A portion of the bottoms 60 is also bled 64 to an FCC unit. The present process, as discussed above, can greatly minimize this wasteful bleed.

In FIG. 5, bottoms 70 from a separation section 71, e.g., a distillation column, is passed to the second stage reactor 72. The recycle to the reactor 72 passes through a reactor 73 comprising a non-zeolite noble metal catalyst. A portion of the bottoms 70 is also passed 74 as bleed to a FCC unit.

The non-zeolite noble metal catalyst employed, in one embodiment, is described in U.S. Pat. No. 9,956,553, the disclosure of which is incorporated herein by reference in its entirety.

The term “noble metal” refers to metals that are highly resistant to corrosion and/or oxidation. Group VIII noble metals include ruthenium (Ru), osmium (Os), rhodium (Rh), iridium (Ir), palladium (Pd), and platinum (Pt).

The terms “macroporous,” “mesoporous,” and “microporous” are known to those of ordinary skill in the art and are used herein in consistent fashion with their description in the International Union of Pure and Applied Chemistry (IUPAC) Compendium of Chemical Terminology, Version 2.3.2, Aug. 19, 2012 (informally known as the “Gold Book”). Generally, microporous materials include those having pores with cross-sectional diameters of less than 2 nm (0.002 μm). Mesoporous materials include those having pores with cross-sectional diameters of from 2 to 50 nm (0.002 to 0.05 μm). Macroporous materials include those having pores with cross-sectional diameters of greater than about 50 nm (0.05 μm). It will be appreciated that a given material or composition may have pores in two or more such size regimes, e.g., a particle may comprise macroporosity, mesoporosity and microporosity.

The noble metal catalyst includes a Group VIII noble metal hydrogenation component supported on a support, with the support, in one embodiment comprising mesopores and macropores.

The Group VIII noble metal hydrogenation component may be selected from Ru, Os, Rh, Ir, Pd, Pt, and combinations thereof (e.g., Pd, Pt, and combinations thereof). The Group VIII noble metal hydrogenation component may be incorporated into the hydrogenation catalyst by methods known in the art, such as ion exchange, impregnation, incipient wetness or physical admixture. After incorporation of the Group VIII noble metal, the catalyst is usually calcined at a temperature between 200° C. to 500° C.

The amount of Group VIII noble metal in the noble metal catalyst may be from 0.05 to 2.5 wt. % (e.g., 0.05 to 1 wt. %, 0.05 to 0.5 wt. %, 0.05 to 0.35 wt. %, 0.1 to 1 wt. %, 0.1 to 0.5 wt. %, or 0.1 to 0.35 wt. %) of the total weight of the catalyst.

Suitable supports include alumina, silica, silica-alumina, zirconia, titania, and combinations thereof. Alumina is a preferred support. Suitable aluminas include γ-alumina, n-alumina, pseudoboehmite, and combinations thereof.

The macroporous support may contain mesopores and macropores in 10 to 10,000 nm (0.01 to 10 μm) range. The mesopore sizes are predominantly in 10 to 50 nm (0.01 to 0.05 μm) range and macropore sizes in 100 to 5,000 nm (0.1 to 5 μm) range. The mean average mesopore diameter is in the range of 10-50 nm (0.01-0.05 μm), preferably in the range of 10 to 20 nm (0.01 to 0.02 μm). The mean average macropore diameter is in the range of 100 to 1,000 nm (0.1 to 1 μm), preferably in the range of 200 to 5,000 nm (0.2 to 0.5 μm).

For the purposes of this disclosure, rather than reporting two mean pore diameters for the support with meso and macroporous pores, the average pore diameter is estimated using the total pore volume and the total surface area for effective comparison with other materials.

The noble metal catalyst may have an average pore diameter of 20 to 1,000 nm (0.02 to 1 μm) (e.g., 20 to 800 nm, 20 to 500 nm, 20 to 200, 25 to 800, 25 to 500, or 25 to 250 nm).

The noble metal catalyst may have a macropore volume of at least 0.10 cc/g (e.g., 0.10 to 0.50 cc/g, 0.10 to 0.45 cc/g, 0.10 to 0.40 cc/g, 0.15 to 0.50 cc/g, 0.15 to 0.45 cc/g, 0.15 to 0.40 cc/g, 0.20 to 0.50 cc/g, 0.20 to 0.45 cc/g, or 0.20 to 0.40 cc/g).

The noble metal catalyst may have a total pore volume of greater than 0.80 cc/g (e.g., at least 0.85 cc/g, at least 0.90 cc/g, at least 0.95 cc/g, >0.80 to 1.5 cc/g, >0.80 to 1.25 cc/g, >0.80 to 1.10 cc/g, 0.85 to 1.5 cc/g, 0.85 to 1.25 cc/g, 0.85 to 1.10 cc/g, 0.90 to 1.50 cc/g, 0.90 to 1.25 cc/g, 0.90 to 1.10 cc/g, 0.95 to 1.50 cc/g, 0.95 to 1.25 cc/g, or 0.95 to 1.10 cc/g).

The fraction of macropore volume relative to the total pore volume of the noble metal catalyst may range from 10 to 50% (e.g., 15 to 50%, 15 to 45%, 15 to 40%, 20 to 50%, 20 to 45%, 20 to 40%, 25 to 50%, 25 to 45%, or 25 to 40%).

The catalyst (and support) can be prepared to include macropores by, for example, utilizing a pore former when preparing the catalyst (and support), utilizing a support that contains such macropores (i.e., a macroporous support), or exposing the catalyst to heat (in the presence or absence of steam). A pore former is a material capable of assisting in the formation of pores in the catalyst support such that the support contains more and/or larger pores than if no pore former was used in preparing the support. The methods and materials necessary to ensure suitable pore size are generally known by persons having ordinary skill in the art of preparing catalysts.

The catalyst (and support) may be in the form of beads, monolithic structures, trilobes, extrudates, pellets or irregular, non-spherical agglomerates, the specific shape of which may be the result of forming processes including extrusion.

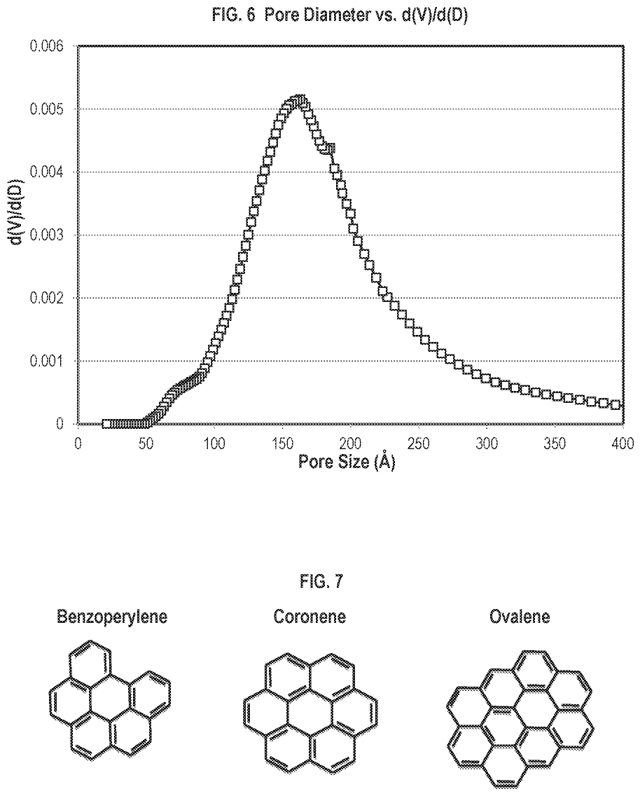

In one embodiment, the non-zeolite noble metal catalyst comprises a bimetallic Pt—Pd catalyst and it does not have zeolite in the composition. In another embodiment, the noble metal catalyst comprises platinum, palladium, gold or a combination thereof, and does not have zeolite in the composition. The pore size is large, because it uses a resid catalyst base. The characteristics of this type of catalyst which promote its selection as a catalyst for HPNA control include: (1) the noble metal catalyst has a stronger hydrogenation ability than the hydrocracking base metal catalyst, and the reaction with the noble metal catalyst is operated at a relatively low temperature favoring hydrogenation of HPNA; (2) Large pores can facilitate mass transfer of the large molecules of HPNAs. The table below summarizes the physical properties of a selected catalyst, in one embodiment. The pore size distribution of the selected catalyst is displayed in FIG. 6. This catalyst was used in the examples, noted as catalyst NZ.

| Catalyst | |
|---|---|
| PtO₂, wt % | 0.19 |
| PdO, wt % | 0.41 |
| Surface Area, m²/g | 113 |
| Total Pore Volume, cc/g | 0.632 |
| Particle Density, g/cc | 0.878 |

The present process is a two-stage hydrocracking process for converting a petroleum feed to lower boiling products. The process comprises hydrotreating a petroleum feed in the presence of hydrogen to produce a hydrotreated effluent stream comprising a liquid product. At least a portion of the hydrotreated stream effluent is passed to a hydrocracking stage, generally comprising more than one reaction zone. The reaction produces a first hydrocracked effluent stream. The first hydrocracked effluent stream is then passed to a second reaction zone of the hydrocracking stage.

The various reaction zones can be operated under conventional conditions for hydrotreating, hydrocracking (and hydrodesulfurization). The conditions can vary, but typically, for either hydrotreating or hydrocracking, the reaction temperature is between about 250′C. and about 500° C. (482° F.-932° F.), pressures from about 3.5 MPa to about 24.2 MPa (500-3,500 psi), and a feed rate (vol oil/vol cat h) from about 0.1 to about 20 hr⁻¹. Hydrogen circulation rates are generally in the range from about 350 std liters H₂/kg oil to 1780 std liters H₂/kg oil (2,310-11,750 standard cubic feet per barrel). Preferred reaction temperatures range from about 340° C. to about 455° C. (644° F.-851° F.). Preferred total reaction pressures range from about 7.0 MPa to about 20.7 MPa (1,000-3,000 psi). The reactors can also be operated in any suitable catalyst-bed arrangement mode, for example, fixed bed, slurry bed, or ebulating bed although fixed bed, co-current downflow is normally utilized.

Further understanding can be achieved upon a closer review of certain figures of the drawing and the following examples.

FIG. 2 in one embodiment, depicts a two-stage hydrocracking system for running the present process. The first operation is mostly hydrogenating the feed to remove most of the heteroatoms in a first stage reactor. Subsequently distillation removes the intermediate products (including catalyst inhibitors such as NH₃ and H₂S), so that the second reactor can focus more exclusively on hydrocracking what is left in the feed boiling range into transportation fuel boiling range. The most refractory compounds left unconverted in the second stage would accumulate in the recycle loop if it were not for a bleed to, e.g., an FCC unit.

More specifically, in one embodiment, FIG. 2 shows an embodiment using a two-stage hydrocracker unit with recycle. The two-stage hydrocracking system has a distillation column 20 between the first stage hydrogenation or hydrotreating stage) 21 and the second stage (hydrocracking stage) 22. Petroleum feed is fed to the first stage with hydrogen 24 to effect hydrogenation. Four beds are shown in the hydrotreating stage, but the number can vary. The hydrogenation removes most of the heteroatoms. Hydrotreated effluent 25 is then fed to a distillation 20 column to separate out intermediate products and catalyst inhibitors such as NH₃ and H₂S. The bottoms of the distillation column 26 are then fed via conduit 27 to the second or hydrocracking stage 22, which also contains a number of superimposed catalyst beds containing hydrocracking catalyst or catalysts. The number of beds or reaction zones can also vary. The bleed stream of the bottoms is generally sent via conduit 28 as an FCC feed.

As the bottoms of the distillation column 26 are fed via conduit 27 to the second stage column 22, the feed passes through reactor 30. This reactor comprises a non-zeolite, noble metal (Pt—Pd) catalyst, and is run at a temperature of about 500° F. (260° C.) or less. In one embodiment, the temperature range for the reaction is from about 400° F. to about 500° F. (204° C. to 260° C.). It is only at these lower temperatures that it has been found HPNA is saturated and converted most effectively. The reactor 20 is within the second stage recycle loop, but upstream of the second stage 22. The recycle loop in FIG. 2 includes the distillation column 20, the second stage 22 and the rector 30, as well as conduits 29, 30, 21, 32, 25, 26, 27, 33 and 34.

From the second stage, the hydrocracked stream can be recycled via 29 to the distillation column 20. The recycle can be recycled directly to the column 20 or can be first combined with the hydrotreated effluent as shown via conduits 29 and 30.

In another embodiment, in FIG. 3, a two-stage hydrocracker unit with recycle is shown where the non-zeolite noble metal catalyst reaction is downstream of the second stage, but in the recycle loop. The two-stage hydrocracking unit shown has a distillation column 40 between the first (hydrogenation or hydrotreating stage) 41 and the second stage (hydrocracking stage) 42. A hydrocarbon feed 43 is feed to the first stage with hydrogen 44 to effect hydrogenation. The number of beds can vary in the first stage column. The hydrogenation removes most of the heteroatoms. Hydrotreated effluent 45 is then feed to the distillation column 40 to separate out intermediate products and catalyst inhibitors such as NH₃ and H₂S. The bottoms of the distillation column 46 are fed via conduit 47 to the second stage 42, the hydrocracking stage. The number of beds in the hydrocracking stage can also vary, as can their purpose. A bleed stream of the bottoms is generally passed via conduit 48 as an FCC feed.

The bottoms of the second stage is recycled via 49. The recycle can be recycled to the distillation column 40 directly, or first to the effluent 45 from the first stage, which effluent is passed to the distillation column. This later recycle is shown in FIG. 3. In the recycle of the second stage bottoms, the bottoms passes through the non-zeolite, noble metal catalyst reactor 50. The reactor 50 comprises a non-zeolite, noble metal, e.g., Pt—Pd, catalyst, and is run at a temperature of about 500° F. (260° C.) or less. In an embodiment, the temperature range for the reaction is from about 400° F. to about 500° F. (204° C. to 260° C.). It is only at these lower temperatures, 500° F. and below, that it has been found HPNA is saturated and converted most effectively. This is demonstrated in the examples below.

Once the bottoms passes through the reactor 50, the reaction product then continues to the distillation column 40, and eventually back to the second stage 42. Thus, the reactor 50 is within the second stage recycle loop, but downstream of the second stage 42.

### Feedstocks

A wide range of petroleum and chemical feedstocks can be hydroprocessed in accordance with the present process. Suitable feedstocks include whole and reduced petroleum crudes, atmospheric and vacuum residua, propane deasphalted residua, e.g., brightstock, cycle oils, FCC tower bottoms, gas oils, including atmospheric and vacuum gas oils and coker gas oils, light to heavy distillates including raw virgin distillates, hydrocrackates, hydrotreated oils, dewaxed oils, slack waxes, Fischer-Tropsch waxes, raffinates, naphthas, and mixtures of these materials. Typical lighter feeds would include distillate fractions boiling approximately from about 175° C. (about 350° F.) to about 375° C. (about 750° F.). With feeds of this type a considerable amount of hydrocracked naphtha is produced which can be used as a low sulfur gasoline blend stock. Typical heavier feeds would include, for example, vacuum gas oils boiling up to about 593° C. (about 1100° F.) and usually in the range of about 350° C., to about 500° C. (about 660° F. to about 935° F.) and, in this case, the proportion of diesel fuel produced is correspondingly greater.

In one embodiment, the process is operated by conducting the feedstock, which generally contains high levels of sulfur and nitrogen, to the initial hydrotreatment reaction stage to convert a substantial amount of the sulfur and nitrogen in the feed to inorganic form with a major objective in this step being a reduction of the feed nitrogen content. The hydrotreatment step is carried out in one or more reaction zones (catalyst beds), in the presence of hydrogen and a hydrotreating catalyst. The conditions used are appropriate to hydrodesulfurization and/or denitrogenation depending on the feed characteristics. The product stream is then passed to the hydrocracking stage in which boiling range conversion is effected. In the present two-stage system, the stream of liquid hydrocarbons from the first hydroconversion stage together with hydrogen treat gas and other hydrotreating/hydrocracking reaction products including hydrogen sulfide and ammonia, preferably passes to separators, such as distillation column, in which hydrogen, light ends, and inorganic nitrogen and hydrogen sulfide are removed from the hydrocracked liquid product stream. The recycle hydrogen gas can be washed to remove ammonia and may be subjected to an amine scrub to remove hydrogen sulfide in order to improve the purity of the recycled hydrogen and so reduce product sulfur levels. In the second stage the hydrocracking reactions are completed. A bed of hydrodesulfurization catalyst, such as a bulk multimetallic catalyst, may be provided at the bottom of the second stage.

### Hydrotreating Catalysts

Conventional hydrotreating catalysts for use in the first stage may be any suitable catalyst. Typical conventional hydrotreating catalysts for use in the present invention includes those that are comprised of at least one Group VIII metal, preferably Fe, Co or Ni, more preferably Co and/or Ni, and most preferably Co; and at least one Group VIB metal, preferably Mo or W, more preferably Mo, on a relatively high surface area support material, preferably alumina. Other suitable hydrodesulfurization catalyst supports include zeolites, amorphous silica-alumina, and titania-alumina noble metal catalysts can also be employed, preferably when the noble metal is selected from Pd and Pt. More than one type of hydrodesulfurization catalyst be used in different beds in the same reaction vessel. The Group VIII metal is typically present in an amount ranging from about 2 to about 20 wt. %, preferably from about 4 to about 12 wt. %. The Group VIB metal will typically be present in an amount ranging from about 5 to about 50 wt. %, preferably from about 10 to about 40 wt. %, and more preferably from about 20 to about 30 wt. %. All metals weight percents are on support (percents based on the weight of the support).

### Hydrocracking Catalysts

Examples of conventional base metal hydrocracking catalysts which can be used in the hydrocracking reaction zones of the second stage, i.e., the hydrocracking stage, include nickel, nickel-cobalt-molybdenum, cobalt-molybdenum and nickel-tungsten and/or nickel-molybdenum, the latter two which are preferred. Porous support materials which may be used for the metal catalysts comprise a refractory oxide material such as alumina, silica, alumina-silica, kieselguhr, diatomaceous earth, magnesia, or zirconia, with alumina, silica, alumina-silica being preferred and the most common. Zeolitic supports, especially the large pore faujasites such as USY can also be used.

A large number of hydrocracking catalysts are available from different commercial suppliers and may be used according to feedstock and product requirements; their functionalities may be determined empirically. The choice of hydrocracking catalyst is not critical. Any catalyst with the desired hydroconversion functionality at the selected operating conditions can be used, including conventional hydrocracking catalysts.

The following examples are meant to be illustrative of the present processes, but not limiting.

### EXAMPLES

### Example 1

In order to illustrate the concept of using a non-zeolite Pt—Pd noble metal catalyst for HPNA control in the second stage recycle loop, a second stage feedstock collected from a two-stage hydrocracker with base metal catalyst loaded in the second stage reactor was used as a testing feed. Three heavy polynuclear aromatic species (benzoperylene, including methyl benzoperylene, coronene, including methyl coronene, and ovalene) which can be quantitatively analyzed by HPLC-UV are the focused HPNAs in the testing. Their structures are shown in FIG. 7.

The HPNA content of the second stage feed from the second stage hydrocracker is listed in the table below as feed A. Additional coronene was added to A to prepare a coronene spiked feedstock B (88 wt ppm coronene) for the testing. Its HPNA content is also listed in the table below as feed B.

| | Feed ID | |
|---|---|---|
| | | B |
| | A | Coronene spiked |
| Feed Description | 2^{nd} stage feed | 2^{nd} stage feed |
| API | 35.4 | 35.4 |
| HPNA by HPLC-UV | | |
| Benzoperylene, ppm | 6.3 | 6.9 |
| Methyl Benzoperylene, ppm | 6.2 | 5.1 |
| Coronene, ppm | 3.6 | 88.4 |
| Methyl Coronene, ppm | 3.3 | 1.9 |
| Ovalene, ppm | 0 | 0 |

A bench scale unit testing was designed to verify HPNA conversion on the non-zeolite Pt—Pd noble metal catalyst NZ, described previously, with the second stage feed A as well as the coronene spiked second stage feed B. The process conditions were: 2300 psig total pressure, 1 h⁻¹ LHSV, 3000 H₂ to Oil, C.A.T.=400˜675° F. The whole liquid product collected at different C.A.T. was submitted for HPNA analysis by HPLC-UV to quantify the unconverted HPNA after processing the feed on the non-zeolite, noble metal catalyst.

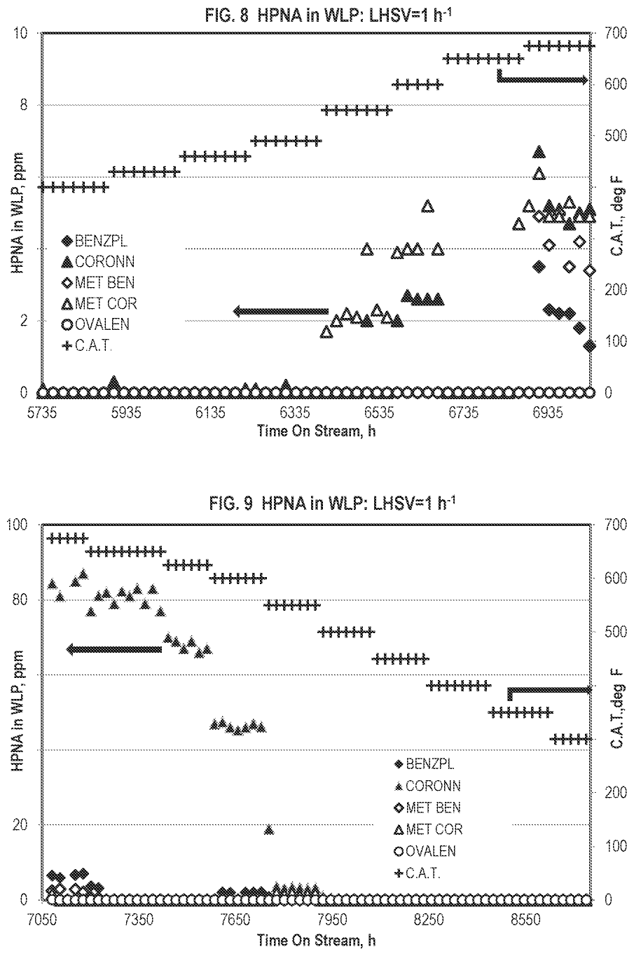

The testing result with the second stage feed A is displayed in FIG. 8.

With the second stage feed A, all the HPNAs (benzoperylene, methyl benzoperylene, coronene, methyl coronene, ovalene) in the feed are saturated and converted when C.A.T. was between 400° F. (204° C.) and 500° F. (260° C.). As C.A.T. was raised to above 500° F., benzoperylene and methyl benzoperylene were converted, but some coronene and methyl coronene were not converted and left in the whole liquid product. When C.A.T. was further increased to above 650° F., all the HPNAs in the feed were not converted at all. In order to have the HPNAs (benzoperylene, methyl benzoperylene, coronene, methyl coronene, ovalene) in the second stage feed saturated and converted, the reactor reaction with the non-zeolite catalyst needs to be operated below 500° F., e.g., between 400° F. and 500° F.

The testing result with the coronene spiked second stage feed B is displayed in FIG. 9.

With the coronene spiked second stage feed B, when C.A.T. was between 400° F. and 500° F., all the spiked coronene, including the other HPNAs (benzoperylene, methyl benzoperylene, methyl coronene, ovalene) in the feed, were saturated and converted. When C.A.T. was raised to 550° F., a small quantity of unconverted coronene (˜2 wt ppm) was found in the whole liquid product, but a majority of the spiked coronene was converted. The coronene conversion continued to decrease as C.A.T. was further increased to 600° F. and 625° F. When C.A.T. was above 650° F., almost no coronene conversion was observed. In addition, the other HPNAs in the feed were not converted at the high temperatures either. This result is consistent with the test on second stage feed A. In order to have the HPNAs (benzoperylene, methyl benzoperylene, coronene, methyl coronene, ovalene) effectively converted, the reactor reaction needs to be operated below 500° F., and preferably between 400° F. and 500° F.

### Example 2

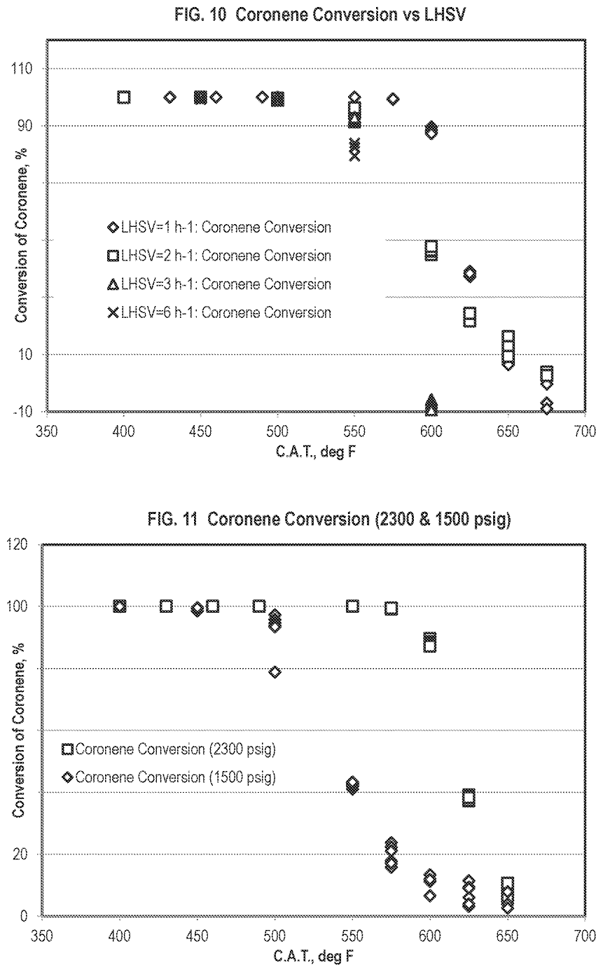

Another test was done to study the impact of LHSV on the conversion of the spiked coronene (88 wt ppm) over the non-zeolite, Pt—Pd catalyst. LHSV was increased from 1 to 2, 3 and eventually to 6 h⁻¹. The plot in FIG. 10 demonstrates the result.

Even if the LHSV increased from 1 h⁻¹ to 6 h⁻¹, all the spiked coronene (88 wt ppm) in the feed could still be converted as long as the C.A.T. was below 500° F. This result demonstrated a small reactor loaded with the noble metal catalyst in the second stage recycle loop can be effective in controlling HPNAs when it is operated at the appropriate temperature (<500° F.).

### Example 3

The impact of operating pressure on the conversion of the spiked coronene (88 wt. ppm) over the non-zeolite noble metal catalyst NZ was also tested. Two operating pressures of 2300 psig and 1500 psig were applied.

Although at 500-600° F. C.A.T., the lower pressure 1500 psig compromised the coronene conversion. When C.A.T. was below 500° F., all the spiked coronene could be converted at 1500 psig. The results are shown in FIG. 11. This result provides a wide operating window of pressure for HPNA control with catalyst NZ in the second stage recycle loop.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

Numerous variations of the present invention may be possible in light of the teachings and examples herein. It is therefore understood that within the scope of the following claims, the invention may be practiced otherwise than as specifically described or exemplified herein.

What is claimed is:

1. A hydrocracking process with a recycle loop for converting a petroleum feed to lower boiling products, which process comprises reacting a hydrocarbon stream in a reactor comprising a non-zeolite noble metal catalyst at a temperature of about 650° F. (343° C.) or less, with the reactor positioned in the recycle loop of the hydrocracking process.

2. The process of claim 1, wherein the process comprises a two-stage hydrocracking process and the reactor comprising the non-zeolite noble metal catalyst is positioned in the recycle loop of the second stage reactor.

3. The process of claim 2, wherein the temperature is about 550° F. (288° C.) or less.

4. The process of claim 3, wherein the temperature is about 500° F. (260° C.) or less.

5. The process of claim 2, wherein the reaction temperature in the reactor in the recycle loop of the second stage reactor is in the range of from about 400° F. to about 500° F. (204° C. to 260° C.).

6. The process of claim 2, wherein the noble metal catalyst comprises a Group VIII noble metal or combinations thereof.

7. The process of claim 2, wherein the noble meal catalyst comprises the metals platinum, palladium, gold or a combination thereof.

8. The process of claim 2, wherein the noble metal catalyst comprises a support having mesopores and macropores.

9. The process of claim 2, wherein the reactor in the recycle loop of the second stage reactor is stationed upstream of the second stage reactor.

10. The process of claim 2, wherein the reactor in the recycle loop of the second stage reactor is stationed downstream of the second stage reactor.

11. A hydrocracking process with recycle for converting a petroleum feed to lower boiling products, which process comprises:
(i) hydrotreating a petroleum feed in the presence of hydrogen to produce a hydrotreated effluent stream comprising a liquid product in a first reactor;
(ii) passing at least a portion of the hydrotreated effluent stream to a separation section;
(iii) passing at least a portion of a bottoms fraction of the separation section to a reactor comprising a non-zeolite noble metal catalyst, which reactor is run at a temperature of about 650° F. (343° C.) or less;
(iv) passing product from the reactor comprising the non-zeolite noble metal catalyst to a hydrocracking reactor to produce a hydrocracked effluent stream; and
(v) recovering a bottoms fraction from the hydrocracking reactor and recycling at least a portion of the bottoms fraction recovered through the separation section in (ii).

12. The process of claim 11, wherein the separation section comprises a distillation column.

13. The process of claim 11, wherein the reactor in (iii) is run at a temperature of about 550° F. (288° C.) or less.

14. The process of claim 11, wherein the reactor in (iii) is run at a temperature of about 500° F. (260° C.) or less.

15. The process of claim 11, wherein the reactor in (iii) is run at a temperature of about 400° F. to 500° F. (204° C. to 260° C.) or less.

16. The process of claim 11, wherein a minimized portion of the bottoms fraction in (v) is passed to an FCC unit.

17. The process of claim 11, wherein the reaction temperature in the reactor in the recycle loop of the second stage reactor is in the range of from about 400° F. to about 500° F. (204° C. to 260° C.).

18. The process of claim 11, wherein the noble metal catalyst comprises a Group VIII noble metal or a combination thereof.

19. The process of claim 11, wherein the noble metal catalyst comprises platinum, palladium, gold or a combination thereof.

20. The process of claim 11, wherein the noble metal catalyst comprises a support which comprises mesopores and macropores.

21. A two-stage hydrocracking process with recycle for converting a petroleum feed to lower boiling products, which process comprises:
(i) hydrotreating petroleum feed in a first stage reactor in the presence of hydrogen to produce a hydrotreated effluent stream comprising a liquid product;
(ii) passing at least a portion of the hydrotreated effluent stream to a separation section;
(iii) passing at least a portion of a bottoms fraction of the separation section to a hydrocracking reactor to produce a hydrocracked effluent stream;
(iv) recovering a bottoms fraction from the hydrocracking reactor and recycling at least a portion of the bottoms fraction recovered to the separation section in (ii) or the hydrotreated effluent stream passed to the separation section in (ii), with the recycled bottoms portions passing through a reactor comprising a non-zeolite noble metal catalyst, which is run at a temperature of 650° F. (343° C.) or less, before reaching the separation section column in (ii) or the hydrotreated effluent stream.

22. The process of claim 21, wherein the separation section comprises a distillation column.

23. The process of claim 21, wherein the reactor comprising a non-zeolite noble metal catalyst in (iv) is run at a temperature of about 550° F. (288° C.) or less.

24. The process of claim 21, wherein the reactor comprising a non-zeolite noble metal catalyst in (iv) is run at a temperature of about 500° F. (260° C.) or less.

25. The process of claim 21, wherein a minimized portion of bottoms fraction from the separation section is passed to an FCC unit.

26. The process of claim 21, wherein the reaction temperature in the reactor comprising a non-zeolite noble metal catalyst in the recycle loop of the hydrocracking reactor is in the range of from about 400° F. to about 500° F. (204° C. to 260° C.).

27. The process of claim 21, wherein the noble metal catalyst comprises a Group VIII noble metal or combinations thereof.

28. The process of claim 21, wherein the noble meal catalyst comprises platinum, palladium, gold or a combination thereof.

29. The process of claim 21, wherein the noble metal catalyst comprises a support which comprises mesopores and macropores.

30. A hydrocracking process with a recycle loop for converting a petroleum feed to lower boiling products, which process comprises reacting a hydrocarbon stream in a reactor comprising a noble metal catalyst with a support having mesopores and macropores, with the reactor at a temperature of about 650° F. (343° C.) or less, and with the reactor positioned in the recycle loop of the hydrocracking process.

31. The process of claim 30, wherein the noble metal catalyst comprises a Group VIII noble metal hydrogenation component on the support having mesopores and macropores.

32. The process of claim 31, wherein the noble metal catalyst has an average pore diameter of 20 to 1,000 nm (0.020 to 1 μm), a total pore volume of greater than 0.8 cc/g, and a macropore volume relative to the total pore volume of from 10 to 50%, wherein the mesopores have a diameter from 10 to 50 nm, and the macropores have a second diameter from greater than 100 to 5,000 nm.
